(19) United States
(12) Patent Application Publication
(10) Pub. No.: US 2008/0238041 A1
(43) Pub. Date: Oct. 2, 2008

(54) Collapsible transport wheelchair

(75) Inventor: Eric Chen, Monrovia, CA (US)

Correspondence Address: DAVID L. DAVIS, ESQ., 90 WASHINGTON VALLEY ROAD, BEDMINSTER, NJ, 07921, US

(73) Assignee: LIFEGEAR, INC.

(21) Appl. No.: 11/728,782

(22) Filed: Mar. 27, 2007

(51) Int. Cl. A61G 5/08

(52) U.S. Cl. 280/650

(57) ABSTRACT

A collapsible transport wheelchair having a frame which is collapsible side-to-side with a scissors-like action and is collapsible front-to-back with a sliding action.

### BACKGROUND OF THE INVENTION

This invention relates to wheelchairs for the disabled and, more particularly, to a transport wheelchair which is lightweight and easily collapsible to a configuration where it can be inserted into a bag for storage and/or carrying.

Transport wheelchairs are known which can be collapsed one-dimensionally into a flattened configuration in which they can be placed in the trunk of a car. It would be desirable, however, to have a transport wheelchair which can be collapsed two-dimensionally to fit into a bag in which it can be stored and/or carried from one location to another.

### SUMMARY OF THE INVENTION

According to the present invention, a frame for a collapsible transport wheelchair comprises a pair of laterally displaced substantially vertical rear members and a pair of rear cross brace members pivotally connected at their lower ends to the rear members, pivotally and slidably connected at their upper ends to the rear members and pivotally connected at a central location to each other. A pair of laterally displaced side members extend angularly upward each to a respective upper end which is pivotally and slidably connected to a respective rear member. Thus, the pair of rear members and the pair of side members are collapsible laterally toward each other, and the pair of side members are slidably collapsible toward the pair of rear members.

According to an aspect of the present invention, the collapsible transport wheelchair further comprises a pair of laterally displaced seat support members which are each pivotally connected at their rear ends to a respective rear member. A pair of front cross brace members are pivotally connected at their lower ends to the side members, pivotally connected at their upper ends to the seat support members and pivotally connected at a central location to each other. A pair of laterally displaced arm rests are provided, each having its rear end pivotally connected to a respective rear member, and a pair of laterally displaced arm rest support members are each pivotally and slidably connected at their lower ends to a respective side member, pivotally and slidably connected at an intermediate portion to a respective seat support member and pivotally connected at their upper ends to a forward end of a respective arm rest.

In accordance with another aspect of this invention, the transport wheelchair further comprises a flexible seat and back which is supported on the seat support members and the rear members.

According to yet another aspect of this invention, the transport wheelchair further comprises a foldable foot rest support bar which extends between the side members and is pivotally connected thereto at their lower ends.

According to a further aspect of this invention, the upper ends of the rear cross brace members and the upper ends of the side members are constrained to slide together along their respective rear members.

### BRIEF DESCRIPTION OF THE DRAWINGS

The foregoing will be more readily apparent from reading the following description in conjunction with the drawings in which like elements in different figures thereof are designated by the same reference numeral and wherein:

FIG. 1 is a front and side perspective view of an exemplary collapsible transport wheelchair constructed in accordance with the present invention, shown in its fully open configuration;

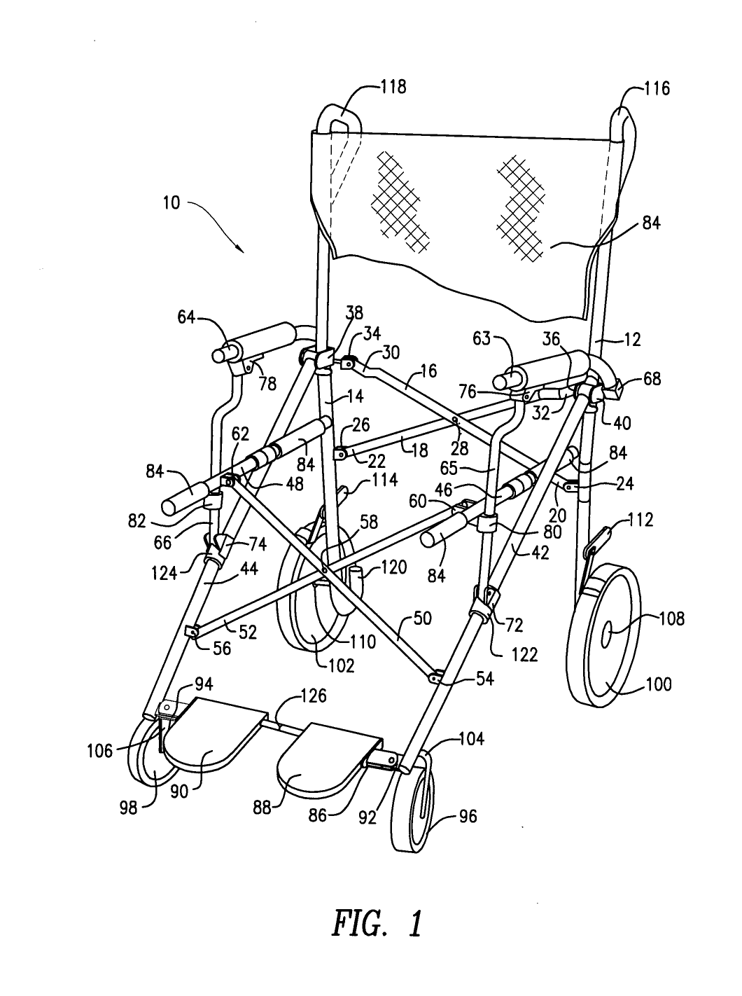

FIG. 2 is a side view of the inventive wheelchair shown in FIG. 1;

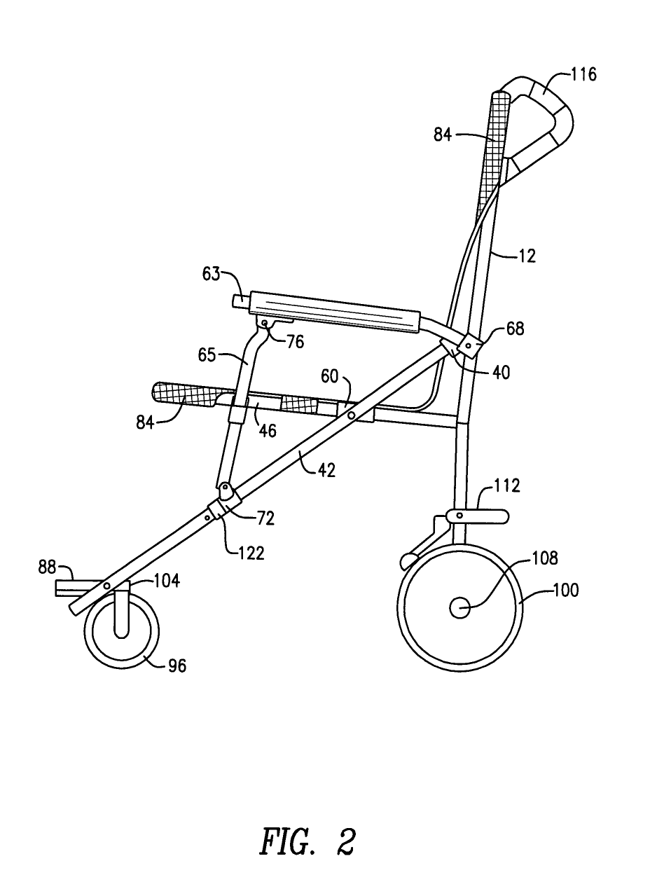

FIG. 3 is a rear view of the inventive wheelchair shown in FIG. 1; and

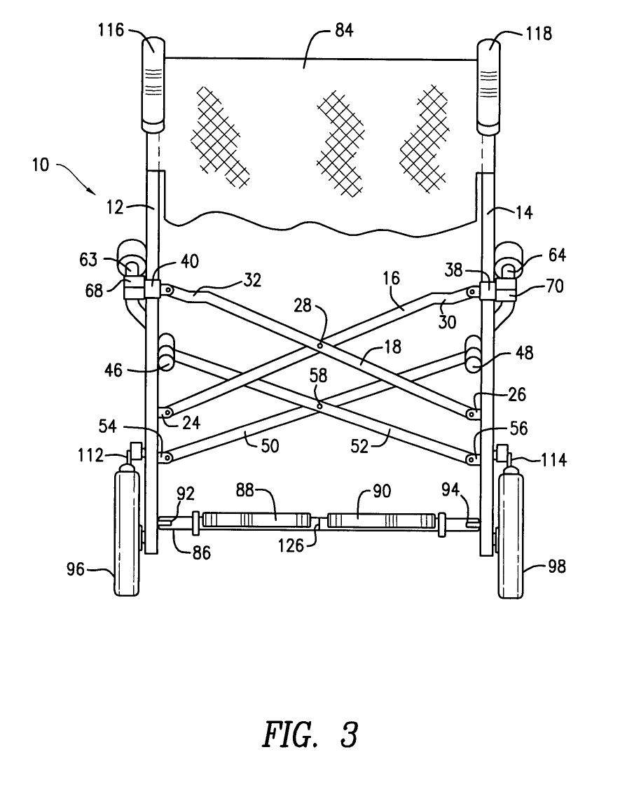

FIG. 4 is a front and side perspective view of the inventive wheelchair shown in FIG. 1, showing the inventive wheelchair in a partial stage of collapse.

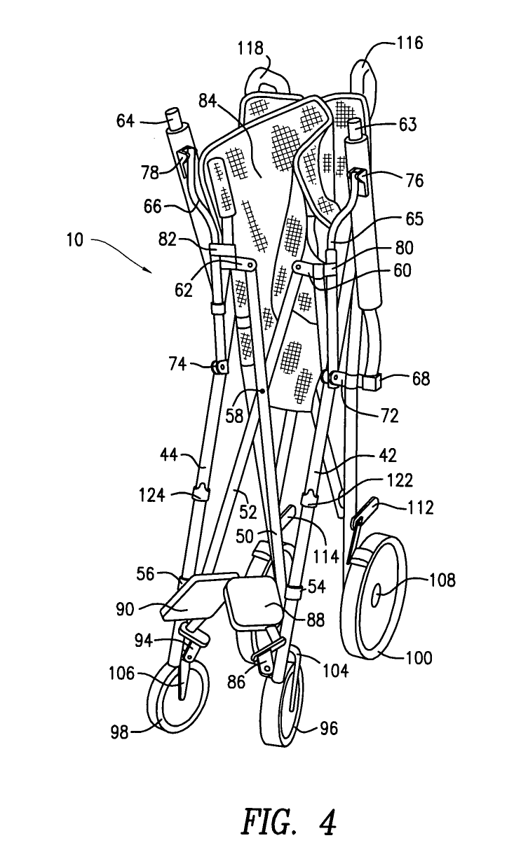

### DETAILED DESCRIPTION

Referring now to the drawings, shown therein is an exemplary collapsible transport wheelchair designated generally by the reference numeral 10 and constructed according to the present invention. The wheelchair 10 includes a frame preferably formed from metal tubing. The frame includes a pair of laterally displaced and substantially vertical rear members 12, 14 and a pair of rear cross brace members 16, 18. The rear cross brace members 16, 18 are pivotally connected at their lower ends 20, 22 to the rear members 12, 14 by the pivot joints 24, 26, respectively. The pivot joints 24, 26 are fixedly secured to the rear members 12, 14, respectively, and are preferably of the type disclosed in U.S. Pat. No. 6,499,906, so that the rear cross brace members 16, 18 can pivotally rotate in three dimensions with respect to the rear members 12, 14. The rear cross brace members 16, 18 are also pivotally connected at a central location 28 to each other (as by a bolt or the like), and are further connected at their upper ends 30, 32, by the pivot joints 34, 36, which are of the same type as the pivot joints 24, 26, to the sliding pivot joints 38, 40. The sliding pivot joints 38, 40 are slidably mounted on the rear members 14, 12, respectively.

The frame of the wheelchair 10 further includes a pair of laterally displaced side members 42, 44 which extend angularly upward and are pivotally and slidably connected at their upper ends to the rear members 12, 14 by the sliding pivot joints 38, 40. Thus, the upper ends of the rear cross brace members 16, 18 and the upper ends of the side members 42, 46 are constrained to slide together along their respective rear members 12, 14.

Each of a pair of laterally displaced seat support members 46, 48 is pivotally connected at its rear end to a respective rear member 12, 14 by a bolt or the like. A pair of front cross brace members 50, 52 are pivotally connected at their lower ends to the side members 42, 44 by the pivot joints 54, 56, respectively. The pivot joints 54, 56 are fixedly secured to the side members 42, 44, respectively, and are preferably of the same type as the pivot joints 24, 26. The front cross brace members 50, 52 are also pivotally connected at a central location 58 to each other (as by a bolt or the like), and are further connected at their upper ends by the pivot joints 60, 62, which are of the same type as the pivot joints 24, 26, to the seat support members 46, 48. The pivot joints 60, 62 are fixedly secured to the seat support members 46, 48, respectively.

The frame of the wheelchair 10 also includes a pair of laterally displaced arm rests 63, 64 and a pair of laterally displaced arm rest support members 65, 66. The arm rests 63, 64 are each preferably covered with a soft cushion for the comfort of the user, and each has its rear end pivotally connected to a respective rear member 12, 14 by the respective fixed pivot joint 68, 70. Each of the arm rest support members 65, 66 has its lower end pivotally and slidably connected to a respective side member 42, 44 by a respective sliding pivot joint 72, 74, and has its upper end pivotally connected to the forward end of a respective arm rest 63, 64 by a respective fixed pivot joint 76, 78. An intermediate portion of each of the arm rest support members 65, 66 is pivotally and slidably connected to a respective seat support member 46, 48 by a respective sliding pivot joint 80, 82. The joints 80, 82 slide along the respective arm rest support members 65, 66 and allow the respective seat support members 46, 48 to pivot thereabout.

So that the wheelchair 10 can hold a person, there is provided a flexible seat and back 84 supported by, and held on, the seat support members 46, 48 and the rear members 12, 14. During the assembly of the wheelchair 10, the seat and back 84 is installed on the members 12, 14, 46, 48 (by being wrapped thereabout and sewn) before those members are assembled to be part of the wheelchair frame. There is also provided a foldable foot rest support bar 86 supporting a pair of foot rests 88, 90. The foot rest support bar 86 extends between the side members 42, 44 and is pivotally connected thereto by the fixed pivot joints 92, 94.

In order that the wheelchair 10 may be moved while holding a person, four wheels 96, 98, 100, 102 are each mounted at the lower end of a respective one of the side and rear members 42, 44, 12, 14 for rotation about a respective substantially horizontal axis. The wheels 96, 98 which are mounted to the side members 42, 44 are each part of a respective caster assembly 104, 106 which is rotatable relative to the respective side member 42, 44 about a substantially vertical axis. Thus, the front wheels 96, 98 swivel to allow the wheelchair 10 to be turned when it is being pushed. The wheels 100, 102 which are mounted to the rear members 12, 14 are each mounted to a respective axle assembly 108, 110 which extends substantially horizontally laterally outwardly from the respective rear member 12, 14.

To prevent the wheelchair 10 from rolling, each of the rear members 12, 14 has mounted thereon a respective lever-operated brake mechanism 112, 114 which is selectively operative for engaging the respective wheel 100, 102 to prevent its rotation, as is conventional in the art.

In order for a person to be able to comfortably push the wheelchair 10, the upper ends of the rear members 12, 14 are bent to form a pair of handles 116, 118, respectively.

When the wheelchair 10 is being pushed, it often encounters a curb, or step, which must be ascended or descended. In such an encounter, it is desirable to be able to raise the front wheels 96, 98. To assist in such raising, the rear member 14 is provided at its lower end with a rearwardly extending portion 120. A person pushing the wheelchair 10 can step on the portion 120 and apply a downward force thereto while pulling back on the handles 116, 118 so that the front wheels 96, 98 are raised. The wheelchair 10 is then rolled on its rear wheels 100, 102 until the rear wheels reach the curb. The pusher then lifts the handles 116, 118 to raise the rear wheels 100, 102 over the curb and rolls the wheelchair on its front wheels 96, 98 until the rear wheels pass the curb.

The frame of the wheelchair 10 also includes a pair of stop members 122, 124 fixedly secured to the side members 42, 44, respectively. The stop members 122, 124 function to limit the downward movement of the sliding pivot joints 72, 74, respectively when the wheelchair is fully opened. Similarly, the fixed pivot joints 68, 70 function as lower stop members for the sliding pivot joints 38, 40.

To collapse the wheelchair 10, the seat 84 is lifted at its front lower end between the seat support members 46, 48. This results in the frame collapsing side-to-side with a scissors-like action due to the front and rear cross brace members 50, 52, 16, 18 pivoting about their central points 58, 28, respectively. The frame also collapses front-to-back with a sliding action due to the sliding pivot joints 38, 40, 72, 74, 80, 82. As the wheelchair 10 is collapsed side-to-side, the foot rest support bar 86 folds at its center hinge 126. When fully collapsed, the wheelchair 10 may be placed into a carry bag (not shown).

Accordingly, there has been disclosed an improved collapsible transport wheelchair having a frame which is collapsible side-to-side with a scissors-like action and is collapsible front-to-back with a sliding action. While a preferred embodiment of the present invention has been disclosed herein, it will be appreciated by those of skill in the art that various adaptations and modifications to the disclosed embodiment are possible, and it is therefore intended that this invention be limited only by the scope of the appended claims.

What is claimed is:

1. A collapsible transport wheelchair comprising:
a pair of laterally displaced substantially vertical rear members;
a pair of rear cross brace members pivotally connected at their lower ends to the rear members, pivotally and slidably connected at their upper ends to the rear members and pivotally connected at a central location to each other;
a pair of laterally displaced side members extending angularly upward each to a respective upper end which is pivotally and slidably connected to a respective rear member;
a pair of laterally displaced seat support members each pivotally connected at its rear end to a respective rear member;
a pair of front cross brace members pivotally connected at their lower ends to the side members, pivotally connected at their upper ends to the seat support members and pivotally connected at a central location to each other;
a pair of laterally displaced arm rests each having its rear end pivotally connected to a respective rear member; and
a pair of laterally displaced arm rest support members each pivotally and slidably connected at its lower end to a respective side member, pivotally and slidably connected at an intermediate portion to a respective seat support member and pivotally connected at its upper end to a forward end of a respective arm rest.

2. The transport wheelchair according to claim 1 further comprising a flexible seat and back supported on the seat support members and the rear members.

3. The transport wheelchair according to claim 1 further comprising a foldable foot rest support bar extending between the side members and pivotally connected thereto at their lower ends.

4. The transport wheelchair according to claim 1 further comprising:
a pair of rear wheels each journalled for rotation at a lower end of a respective rear member; and
a pair of front wheels each journalled for rotation at a lower end of a respective side member.

5. The transport wheelchair according to claim 4 wherein each of the front wheels is part of a caster assembly rotatable relative to the respective side member about a respective substantially vertical axis.

6. The transport wheelchair according to claim 4 further comprising a pair of axle assemblies each secured to a lower end of a respective one of rear members and extending substantially horizontally laterally outward from the respective rear member, wherein each of the wheels mounted to the rear members is mounted to a respective one of said pair of axle assemblies for rotation relative to the respective rear member about a respective horizontal axis.

7. The transport wheelchair according to claim 4 further comprising a brake mechanism associated with each of said rear members and selectively operative for engaging a respective rear wheel to prevent rotation thereof.

8. The transport wheelchair according to claim 1 further comprising a respective handle formed at the upper end of each of said rear members.

9. The transport wheelchair according to claim 1 wherein one of said rear members is formed with a rearwardly extending portion at a lower end thereof; whereby a person pushing the wheelchair can step on the rearwardly extending portion and apply a downward force thereto to raise the front end of the wheelchair so that the wheelchair can ascend a curb or the like.

10. The transport wheelchair according to claim 1 wherein the upper ends of the rear cross brace members and the upper ends of the side members are constrained to slide together along their respective rear members.

11. A frame for a collapsible transport wheelchair, comprising:
a pair of laterally displaced substantially vertical rear members;
a pair of rear cross brace members pivotally connected at their lower ends to the rear members, pivotally and slidably connected at their upper ends to the rear members and pivotally connected at a central location to each other; and
a pair of laterally displaced side members extending angularly upward each to a respective upper end which is pivotally and slidably connected to a respective rear member;
whereby the pair of rear members and the pair of side members are collapsible laterally toward each other, and the pair of side members are slidably collapsible toward the pair of rear members.

12. The frame for a collapsible transport wheelchair according to claim 11 further comprising a respective handle formed at the upper end of each of said rear members.

13. The frame for a collapsible transport wheelchair according to claim 11, wherein the upper ends of the rear cross brace members and the upper ends of the side members are constrained to slide together along their respective rear members.

14. The frame for a collapsible transport wheelchair according to claim 11, further comprising:
a pair of laterally displaced seat support members each pivotally connected at its rear end to a respective rear member;
a pair of front cross brace members pivotally connected at their lower ends to the side members, pivotally connected at their upper ends to the seat support members and pivotally connected at a central location to each other;
a pair of laterally displaced arm rests each having its rear end pivotally connected to a respective rear member; and
a pair of laterally displaced arm rest support members each pivotally and slidably connected at its lower end to a respective side member, pivotally and slidably connected at an intermediate portion to a respective seat support member and pivotally connected at its upper end to a forward end of a respective arm rest.

15. A transport wheelchair comprising the frame according to claim 14 and further comprising a flexible seat and back supported on the seat support members and the rear members.

16. A transport wheelchair comprising the frame according to claim 14 and further comprising a foldable foot rest support bar extending between the side members and pivotally connected thereto at their lower ends.

17. A transport wheelchair comprising the frame according to claim 14 and further comprising:
a pair of rear wheels each journalled for rotation at a lower end of a respective rear member; and
a pair of front wheels each journalled for rotation at a lower end of a respective side member.

18. The transport wheelchair according to claim 17 wherein each of the front wheels is part of a caster assembly rotatable relative to the respective side member about a respective substantially vertical axis.

19. The transport wheelchair according to claim 17 further comprising a pair of axle assemblies each secured to a lower end of a respective one of rear members and extending substantially horizontally laterally outward from the respective rear member, wherein each of the wheels mounted to the rear members is mounted to a respective one of said pair of axle assemblies for rotation relative to the respective rear member about a respective horizontal axis.

20. The transport wheelchair according to claim 17 further comprising a brake mechanism associated with each of said rear members and selectively operative for engaging a respective rear wheel to prevent rotation thereof.

21. A transport wheelchair comprising the frame according to claim 14, wherein one of said rear members is formed with a rearwardly extending portion at a lower end thereof; whereby a person pushing the wheelchair can step on the rearwardly extending portion and apply a downward force thereto to raise the front end of the wheelchair so that the wheelchair can ascend a curb or the like.
